(19) United States
(12) Patent Application Publication
(10) Pub. No.: US 2005/0283337 A1
(43) Pub. Date: Dec. 22, 2005

(54) System and method for correlation of time-series data

(76) Inventor: Mehmet Sayal, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/873,556

(22) Filed: Jun. 22, 2004

(51) Int. Cl. G06F 7/00

(52) U.S. Cl. 702/179

(57) ABSTRACT

Embodiments of the present invention relate to a system and method for discovering time correlations among data. The method may include inputting time-series data and summarizing the time-series data at different time granularities. Additionally, the method may involve detecting change points in the time-series data, reducing a comparison of the time-series data to a one-to-one comparison, comparing the time-series data to generate correlation rules, and detecting correlations between the time-series data based on the correlation rules.

### BACKGROUND OF THE RELATED ART

Data correlation may be defined as the identification of causal, complementary, parallel, or reciprocal relationships between two or more comparable data. Alternatively, data correlation may be defined as the identification of qualitative correspondences between two or more comparable data. Prior solutions for discovering such correlations among data generally concentrate on enumeration data, where the data field entries can take one of a limited number of values that may easily be categorized for analysis. For example, a data field used for storing country names may contain only a few hundred unique data values, which can easily be categorized as enumeration data. A correlation analysis on such data can yield results like: “When customer name is customer1 then product name is Printer with 60% probability.”

Discovering correlations between numeric data that is recorded at a given time is relatively easy compared to discovering correlations in data that change over time. Analysis of data that is not time based results in correlations corresponding to a snapshot of time. Analysis of different snapshots may result in generalized correlation rules, such as “When Price is more than $1000, the Priority Level is 5.” These generalized rules are, however, not as accurate as could be obtained by an analysis of time-based data.

Performing data correlation may be important in many different fields including computing fields because it makes possible the identification of interesting and useful relationships among data. For example, data correlation may be applied on business activity log data to identify correlations among business objects, such as how one business object affects the others.

### BRIEF DESCRIPTION OF THE DRAWINGS

FIG. 1 is a block diagram illustrating a system for detecting data correlations in accordance with embodiments of the present invention;

FIG. 2 is a diagram illustrating data aggregation in accordance with embodiments of the present invention; and

FIG. 3 is a flow diagram showing an exemplary process in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

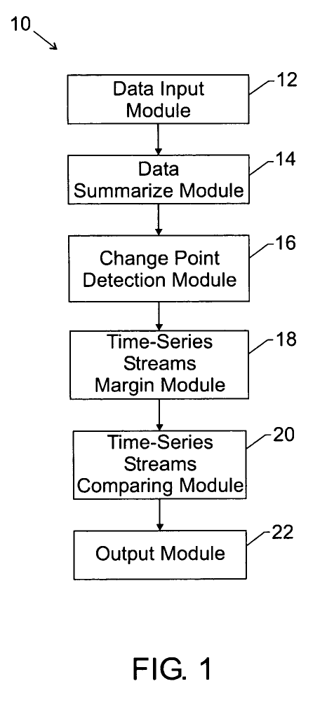

FIG. 1 is a block diagram illustrating a system for detecting data correlations in accordance with embodiments of the present invention. The system is generally referred to by reference number 10. While FIG. 1 separately delineates specific modules, in other embodiments, individual modules may be split into multiple modules or combined into a single module. For example, in some embodiments of the present invention, the modules in the illustrated system 10 do not necessarily operate in the illustrated order. Further, individual modules and components may represent hardware, software, steps in a method, or some combination of the three.

Embodiments of the present invention such as that shown in FIG. 1 relate to identifying time correlations (i.e., correlations between numeric values over the course of time), which may indicate time-based relationships among data objects (time-series data). Time correlations are very important in business impact analysis, forecasting, prediction, simulation, and so forth.

One embodiment of the present invention comprises a method for automatically determining time correlations among numeric data, and generating time correlation rules that can be reused for further analysis or reporting purposes. Further, embodiments of the present invention are generic enough for utilization in many different computational fields, including data analysis, reporting, data mining, data integration, and so forth, to automatically discover time correlations in numeric data.

For example, one embodiment of the present invention may produce time correlations such as “When Price increases more than 5%, the Total Sales drop at least 4% within the next 3 days.” In another example, embodiments of the present invention may produce a time correlation such as “When there is a significant increase in Cost, the Profit decreases significantly in the next week.”

Data values of numeric data objects are often recorded with time-stamps as snapshots of time, thus yielding time-series data. It should be noted that because merged time-series data, which will be discussed in further detail below, has the same data structure as regular time-series data, the term “time-series data” may refer to both regular and merged time-series data. Table 1A below illustrates an example database containing three time-series data for the grades of a high school student: Math, Physics, and English. Embodiments of the present invention comprise methods that can be used for automatically determining time correlations within such multiple time-series data. Further, time correlations that are generated by embodiments of the present invention may include such information as correlation type (e.g., same or opposite direction), sensitivity (e.g., the magnitude of change in the value of one data object compared to the change in values of other data objects), and time distance between changes (e.g., time delay).

TABLE 1A
Example database table containing time-series data

| Name | Value | Time-stamp |
|---|---|---|
| Math | 85 | Jan. 12, 2002 |
| Physics | 93 | Jan. 26, 2002 |
| English | 74 | Feb. 20, 2002 |
| Math | 96 | Mar. 23, 2002 |
| Physics | 81 | Apr. 2, 2002 |
| English | 65 | Apr. 5, 2002 |
| . | . | . |
| . | . | . |
| . | . | . |
| Math | 97 | Jan. 10, 2003 |
| . | . | . |
| . | . | . |
| . | . | . |

Specifically, FIG. 1 illustrates a system comprising modules for inputting data (block 12), summarizing data (block 14), detecting change points (block 16), merging time series streams (block 18), comparing time series streams (block 20), and output (block 22). Data input for use by the system may be any kind of data stream that is time-stamped (i.e., “time-series” data). Further, input data may be read from one or more database tables, an XML document, a flat text file with character delimited data fields, or the like. At the other end of the system 10, the output (block 22) may represent a set of time correlation rules that describe data object fields correlated to each other.

Each time correlation rule may include information regarding direction, sensitivity, and time delay. Direction may be a change in value related to time-series data. For example, a direction may be “positive” if the change in the value of one time-series data is correlated to a change in the same direction for another time-series data and “negative” if the change direction is opposite in the two correlated time-series. Sensitivity may relate to a magnitude of change in data values. For example, the magnitude of change in data values in two correlated time-series may be recorded in order to indicate how sensitive one time-series is to the changes in another time-series. Additionally, the time delay for correlated time-series data may be recorded in order to explain how much time it takes to see the effect of a change in the value of one time-series as a result in the value of another time-series.

Embodiments of the present invention may detect several types of correlations between time-series data streams including simple correlations, quantified correlations, and time correlations. A simple correlation may indicate a direct correspondence between two or more time series data. A quantified correlation may be an extension of the simple correlation in which numeric quantifications are provided regarding the direct correspondence. A time correlation may be a complicated correlation that not only relates to numeric quantification about data values but also time distance measurements for a cause and effect relationship among time series data. The following relationships (a), (b), and (c) are exemplary simple, quantified, and time correlations respectively:
city=“Los Angeles”→population=“high” (confidence: 100%) (a)
A=5 or A=6→B>50 (confidence: 75%) (b)
A increases more than 5%→B will increase more than 10% within 2 days (confidence: 80%) (c)

Embodiments of the present invention may detect all three correlation types shown discussed above, including time correlations. Detection of time correlations provides significant advantages because in most systems there is a certain time delay (e.g., not simultaneous) before the effect of a change may be observed.

The summarizing data module (block 14) illustrated in FIG. 1 may comprise summarizing data, such as time-series data, at different time granularities (e.g., seconds, minutes, hours, days, weeks, months, years). It may be necessary to summarize the time-stamped numeric data values (i.e., time-series data) for at least two reasons. First, the volume of time-series data is usually very large, which tends to create analysis problems. Second, time-stamps may not match each other, making it difficult to compare time-stamped data with other time-stamped data, where the time stamps have different formats.

When the volume of time-series data is very large, it may be more time efficient to summarize the data before analyzing it. For example, if there are thousands of data records for each minute of a process operation period, it may be more time efficient to summarize the data at minute level (e.g. by taking mean, count, and standard deviation of recorded values). Such summarized data may be more concise and can be analyzed in a more time efficient manner.

If time stamps are of differing formats, summarization of the data may be necessary to allow comparison of data having mismatched time-stamps. For example, all of the exams in Table 1A have a different recording time. In other words, each exam in Table 1A has a different time-stamp. Accordingly, it is not possible to compare the exam scores having identical time-stamps, because there is not enough recorded data at each time-stamp value to compare different time-series values. Summarizing the numeric data (e.g. taking the average value for each course) by day wouldn't be useful either, because all exam scores were recorded on different days. Even summarizing the scores by month may not be enough, in this example, because each month of the year does not contain a recorded value for every time-series (i.e., for every course). Consequently, it may be necessary to summarize data using higher time granularity so that the recorded numeric data are comparable with each other. If additional time-stamp information is provided, such as the notion of an academic calendar year, or business calendar units (e.g., financial quarter or financial year), then those may also be used as data aggregation attributes.

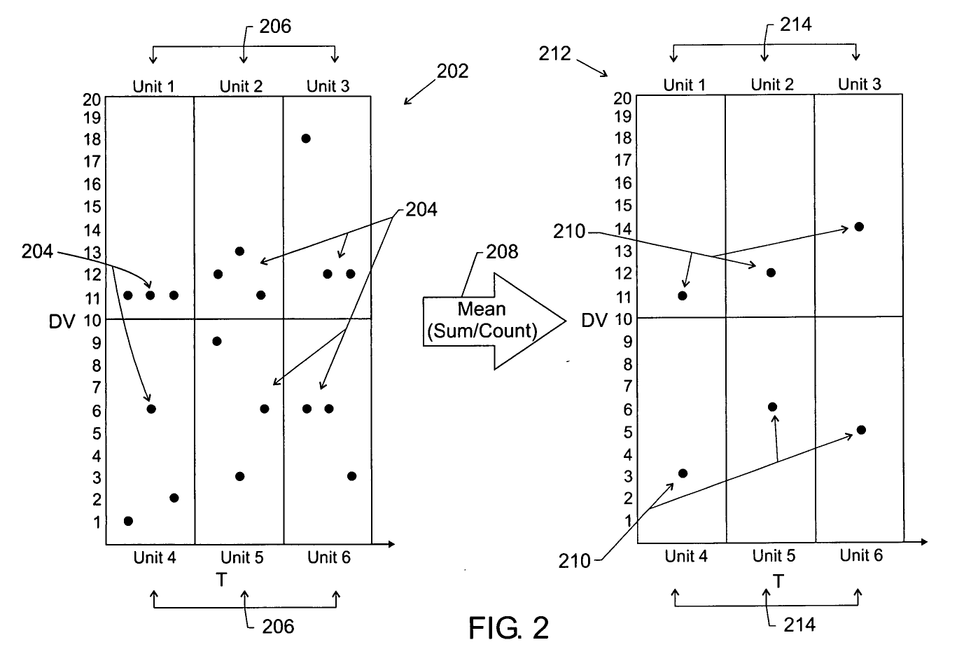

FIG. 2 is a diagram illustrating data aggregation in accordance with embodiments of the present invention. The summarizing data module (block 14) may comprise data aggregation. Accordingly, FIG. 2 illustrates an example of how data aggregation can be done at any particular time granularity level (e.g., minutes, hours, days, and so forth) using two graphs. In a first graph 202, exemplary raw data 204 are plotted according to associated data values (DV on the Y-axis) and time-stamps (T on the X-axis). The first graph 202 is divided into time/value units 206 that are each individually labeled (e.g., Unit 1, Unit 2 and so forth). The aggregation may be performed by calculating the sum, count, mean, min, max, and standard deviation of individual data values within each time/value unit 206.

In one embodiment of the present invention, the raw data 204 illustrated in the first graph 202 is summarized by adding all of the data values represented in each time/value unit 206, and dividing the acquired total by the count of raw data 204 within that same time/value unit 206. For example, in Unit 1 shown in the first graph 202, the sum of data values would be 33 (i.e., 11+11+11) and this sum would be divided by the number of data points in the same unit (i.e. 3). This summarization procedure is represented by arrow 208 in FIG. 2 and its results are referred to as summarized data 210, which is illustrated in a second graph 212.

In the second graph 212, the summarized data 210 are plotted against the same axis values used in the first graph 202 (i.e., DV and T). Like the first graph 202, the second graph 212 in FIG. 2 is divided into time/value units 214. The time/value units of the second graph 212 correspond to the time/value units of the first graph 202 and are labeled accordingly. For example, the raw data in Unit 1 of the first graph 202 is summarized in Unit 1 of the second graph 212. Accordingly, Unit 1 in the second graph contains a summarized data point 210 with a data value of 11 (i.e., 33/3) as calculated previously.

The detecting change points module (block 16) illustrated in FIG. 1 may comprise detecting change points using a statistical method such as a cumulative sum (CUSUM). CUSUM is a simple and effective statistical method for detecting change points in time-stamped numeric data or time-series data. It should be noted that the CUSUM is not the cumulative sum of the data values but the cumulative sum of differences between the values and the average. For example, CUSUM at each data point may be calculated, as follows. First, the mean (or median) of the data may be subtracted off of each data point's value. Next, for each point, all the mean/median-subtracted points before it may be added. Then, the resulting values may be defined as the Cumulative Summary (CUSUM) for each point.

The CUSUM test may be useful for picking out general trends from random noise because noise may tend to cancel out as an increasing number of values are evaluated. For example, there are generally just as many positive values of true noise as there are negative values of true noise and these values will generally cancel one another. A trend may be visible as a gradual departure from zero in the CUSUM. Therefore, in one embodiment of the present invention, CUSUM may be used for detecting not only sharp changes, but also gradual but consistent changes in numeric data values over the course of time.

In one embodiment of the present invention, once a CUSUM value for every data point is calculated, the calculated CUSUM values are compared with upper and lower thresholds to determine which data points may be marked as change points. The data points for which the CUSUM value is above the upper threshold or below the lower threshold may be marked as change points. In one embodiment of the present invention, the upper and lower thresholds may be determined using standard deviation (i.e. a fraction or factor of standard deviation). A moving mean or standard deviation is generally readily calculable using a moving window. Therefore, it may be assumed that standard deviation can be readily calculated on any time-series data. In another embodiment of the present invention, the upper and lower thresholds are determined by a similar calculation or set to two constant values.

Once change points are established, the change points may be labeled. In one embodiment of the present invention, the detected change points are marked with labels indicating the direction of the detected change. For example, a point may be marked “Down” where a trend of data values changes from up to down or a point may be marked “Up” where a trend of data values changes from down to up. Further, an amount of change may be recorded for each change point.

The merging and comparing modules (block 18 and block 20) illustrated in FIG. 1 may comprise a process of identifying time correlations among multiple time-series data streams. Embodiments of the present invention may operate by first reducing time-series comparisons such that the problem of comparing multiple time-series data streams can be more efficiently done. In order to properly present the merging and comparing modules (block 18 and block 20) discussed above, it may be necessary to define certain terms including “one-to-one,” “many-to-one,” and “many-to-many,” which are used to describe time-series comparisons.

One-to-one may be defined as the comparison of two time-series data streams with each other. This is the simplest form of time-series comparison, wherein the purpose may be to find out if there exists a time correlation between two time-series. For example, if A and B identify two time-series data streams, one-to-one comparison generally tries to find out if changes in data values of A have any time delayed impact on changes in data values of B. The one-to-one comparison may be denoted A→B.

Many-to-one may be defined as the comparison of multiple time-series data streams with a single time-series data stream. For example, if A, B and C identify three time-series data streams, many-to-one comparison generally tries to find out if changes in data values of A and B collectively have a time delayed impact on changes in data values of C. This comparison may be denoted A*B→C.

Many-to-many may be defined as the comparison of multiple time-series data streams with multiple time-series data streams. For example, if A, B, C and D identify four time-series data streams, many-to-many comparison tries to find out if changes in data values of A and B collectively have a time delayed impact on changes in data values of C and D. This comparison may be denoted A*B→C*D.

Embodiments of the present invention reduce many-to-one and many-to-many time-series comparisons into one-to-one time-series comparison (block 18). For example, data values of A may be combined with data values of B to produce what may be referred to as AB for comparison with C. Accordingly, a many-to-one comparison of (A*B→C) may be reduced to a one-to-one comparison (AB→C). Additionally, when reducing comparisons to one-to-one, the reductions may be reused. AB may be reused to combine with C to reduce a further many-to-many comparison (e.g., A*B*C→D*E) to a one-to-one comparison (e.g., ABC→DE) without recombining A and B. Such one-to-one time-series comparison may be applicable to any combination of time-series comparisons as a result of such reduction. Further, embodiments of the present invention perform one-to-one time-series comparison in order to extract time correlation rules (block 22). These time correlation rules may be easily stored and used for further analysis.

In one embodiment of the present invention, a reduction technique such as convolution may be used to reduce multiple time-series data streams into a single time-series data stream. Convolution is a computational method wherein an integral expresses the amount of overlap of one function g(x) as it is shifted over another function f(x). Accordingly, convolution may essentially “blend” one function with another. For example, convolution of two functions f(x) and g(x) over a finite range is given by the equation:
f*g≡∫₀^{f}f(τ)g(t−τ)dτ (1)
where f*g denotes the convolution of f and g.

As discussed above, embodiments of the present invention may compare two time-series data streams (block 20). In one embodiment, a statistical correlation may be utilized to calculate the time correlation between the two time-series data streams. Further, the time-series data streams that are compared may correspond to either merged time-series or regular time-series. The statistical correlation (cor) between two time-series may be calculated as:

$$cor ( x , y ) = \frac{cov ( x , y )}{σ ( x ) σ ( y )} \qquad ( 2 )$$

where x and y identify two time-series, σ(x) corresponds to the standard deviation of values in time-series x, and σ(y) corresponds to the standard deviation of values in time-series y. Additionally, covariance (cov) is calculated as:
cov(X, Y)=E{[X−E(X)][Y−E(Y)]} (3)
where E(X) and E(Y) correspond to the mean values of time-series data values from x and y.

Time correlation may be calculated as follows:
max {cor(xᵢ,yⱼ)} ∀i,j ∈ t; i≠j (4)
where t corresponds to aggregated time span of the time-series data (e.g., minutes, hours, days, and so forth).

Sensitivity may be calculated using the following formula:
measure cor(xᵢ,yⱼ) where i,j ∈ t; i≠j, |i−j|=d (5)
where the distance (d) is set between i and j to that of the maximum statistical correlation found. The time distance for the maximum statistical correlation found between two time-series data streams may be denoted d.

Accordingly, the statistical correlation between aggregated data points with varying time distances may be calculated. Further, the maximum calculated correlation and the corresponding time distance (d) may provide the time correlation information between the compared time-series data streams. The sensitivity may be calculated using time distance (d) of the calculated maximum statistical correlation. The direction of correlation may also be obtained from the calculated statistical correlation.

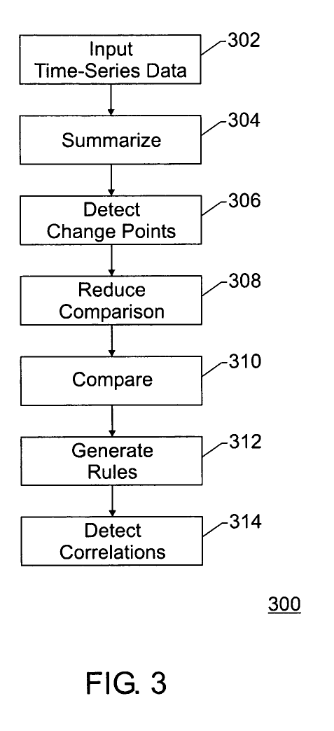

FIG. 3 is a flow diagram showing an exemplary process in accordance with embodiments of the present invention. The illustrated exemplary method is generally referred to by reference numeral 300. Specifically, in method 300, block 302 represents inputting time-series data. Block 304 represents summarizing the time-series data at different time granularities. Block 306 represents detecting change points in the time-series data. Block 308 represents reducing a comparison of the time-series data to a one-to-one comparison. Block 310 represents comparing the time-series data to generate correlation rules, as illustrated by block 312. Block 314 represents detecting correlations between the time-series data based on the correlation rules.

In one embodiment of the present invention, once the time correlation is calculated, the confidence may also be calculated by comparing the percentage of times the calculated statistical correlation with the time delay (d) of the maximum correlation is higher than a particular threshold. For example, if the proposed method finds out that the time correlation is the highest for a time delay of 3 units, say 3 days (i.e., d=3 days), then the confidence may be calculated by measuring what percentage of the time xᵢ and yⱼ values have a statistical correlation larger than a particular threshold. Further, in one embodiment, the threshold can be chosen by a user.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A processor-based method for discovering time correlations among data, comprising:
inputting time-series data;
summarizing the time-series data at different time granularities;
detecting change points in the time-series data;
reducing a comparison of the time-series data to a one-to-one comparison;
comparing the time-series data to generate correlation rules; and
detecting correlations between the time-series data based on the correlation rules.

2. The method of claim 1, comprising reducing the comparison using convolution.

3. The method of claim 1, comprising using statistical correlation to calculate a time correlation between time-series data.

4. The method of claim 1, comprising identifying time-series data streams as the time-series data.

5. The method of claim 1, comprising merging multiple time-series data.

6. The method of claim 1, comprising storing the correlation rules for subsequent use without regenerating the correlation rules.

7. The method of claim 1, comprising reading input from an XML document.

8. The method of claim 1, comprising reading input from a flat text file with character delimited data fields

9. The method of claim 1, comprising detecting at least one of a simple correlation, a quantified correlation, and a time correlation.

10. The method of claim 1, comprising determining that the comparison is already one-to-one.

11. A system for discovering time correlations among data, comprising:
a time-series data input module adapted to receive time-series data;
a data summarizing module adapted to summarize the time-series data at different time granularities;
a detection module adapted to detect change points in the time-series data;
a reduction module adapted to reduce a comparison of the time-series data to a one-to-one comparison;
a comparison module adapted to compare the time-series data to generate correlation rules; and
a correlation detection module adapted to detect correlations between the time-series data based on the correlation rules.

12. The system of claim 11, comprising a convolution module adapted to reduce the comparison using convolution.

13. The system of claim 11, comprising, a statistical module adapted to use statistical correlation to calculate a time correlation between time-series data.

14. The system of claim 11, comprising a multiple merge module adapted to merge multiple time-series data.

15. The system of claim 11, comprising a storage module adapted to store the correlation rules for subsequent use without regenerating the correlation rules.

16. The system of claim 11, comprising an input reading module adapted to read input from an XML document.

17. The system of claim 11, comprising a variable detection module adapted to detect at least one of a simple correlation, a quantified correlation, and a time correlation.

18. A computer program for discovering time correlations among data, comprising:
a tangible medium;
a time-series data input module stored on the tangible medium, the time-series data input module adapted to input time-series data;
a data summarizing module stored on the tangible medium, the data summarizing module adapted to summarize the time-series data at different time granularities;
a detection module stored on the tangible medium, the detection module adapted to detect change points in the time-series data;
a reduction module stored on the tangible medium, the reduction module adapted to reduce a comparison of the time-series data to a one-to-one comparison;
a comparison module stored on the tangible medium, the comparison module adapted to compare the time-series data to generate correlation rules; and
a correlation detection module stored on the tangible medium, the correlation detection module adapted to detect correlations between the time-series data based on the correlation rules.

19. The computer program of claim 18, comprising a convolution module stored on the tangible medium, the convolution module adapted to reduce the comparison using convolution.

20. The system of claim 18, comprising, a statistical module stored on the tangible medium, the statistical module adapted to use statistical correlation to calculate a time correlation between time-series data.

21. The system of claim 18, comprising a multiple merge module stored on the tangible medium, the multiple merge module adapted to merge multiple time-series data.

22. A system for discovering time correlations among data, comprising:
means for inputting time-series data;
means for summarizing the time-series data at different time granularities;
means for detecting change points in the time-series data;
means for reducing a comparison of the time-series data to a one-to-one comparison;
means for comparing the time-series data to generate correlation rules; and
means for detecting correlations between the time-series data based on the correlation rules.
